(19) United States
(12) Patent Application Publication
(10) Pub. No.: US 2026/0139926 A1
(43) Pub. Date: May 21, 2026

(54) ADAPTIVE SHOT PATTERNS

(71) Applicant: BAE SYSTEMS BOFORS AB, SE-69180 Karlskoga (SE)

(72) Inventors: Erik JONASSON, Väse (SE); Frans ERIKSSON, HAMMARÖ (SE)

(73) Assignee: BAE SYSTEMS BOFORS AB, SE-69180 Karlskoga (SE)

(21) Appl. No.: 19/125,376

(22) PCT Filed: Nov. 12, 2023
(86) PCT No.: PCT/SE2023/051146

§ 371 Date: Apr. 29, 2025

(30) Foreign Application Priority Data
Nov. 23, 2022 (SE) 2200135-8

(51) Int. Cl. F41G 3/04; F41F 1/00; F41G 3/08; F41H 11/02

(52) U.S. Cl. CPC F41G 3/04; F41G 3/08; F41H 11/02; F41F 1/00

(57) ABSTRACT

A method for shot pattern selection when combating targets with an impact system includes estimating the position of the target, estimating the speed of the target, categorizing the type of target, selecting the type of shot pattern, and firing projectiles based on the selected shot pattern. A fire-control system and an impact system are also provided.

### BACKGROUND AND SUMMARY

The present patent application relates to a method for arranging shot patterns, a fire-control system, and an impact system.

When combating a moving or stationary target with unguided or guided projectiles fired from barreled weapons, the projectiles must be fired at the points where the target will be when the projectiles reach it, or at points close to where the target is located. Such points, usually called forward points, must be predicted. In order to improve impact on the target or to improve the probability of impact on the target, multiple projectiles can be arranged in a shot pattern in the vicinity of the target or in the vicinity of the predicted forward points.

Examples of method and device for the arrangement of a shot pattern are given in patent document RU 2 373 485 C2. The patent document demonstrates that several projectiles are fired in succession with a leading projectile guiding subsequent projectiles. The arrangement of shot patterns thus takes place once the projectiles have been fired from the barrel and assumes the use of projectiles capable of being guided.

The problem with current available solutions according to the above-mentioned document is that there is no indication for choosing shot patterns based on an assumption about the target object, a classification about the target object.

In existing solutions, the shot patterns are not adapted to their distance from the target object. The spread of the launch device will thus affect the spread of the shot pattern depending on distance, and current solutions do not provide any way to adapt to this. Furthermore, the shot patterns are not adapted to the target being in motion.

Additional problems which the present invention seeks to solve will become apparent in connection with the following detailed description of the various embodiments.

It is desirable to improve the ability to combat a target by causing several projectiles to explode simultaneously near a target in a certain pattern, a so-called shot pattern.

By firing a succession of projectiles in a certain pattern, a shot pattern, the projectiles, or at least one of the projectiles, can be made to be close to the target.

By arranging the projectiles burst in a shot pattern, an improved effect can be achieved, partly because a larger amount of energetic material can burst by using several projectiles, which means that a larger amount of shrapnel can be generated within the same target area, and partly because a certain variation in the position of the projectiles means that a larger area can be covered by shrapnel.

The invention relates, according to an aspect thereof, to a method for shot pattern selection when combating targets with an impact system, whereas the following method steps are included;
i.) estimating the position of the target,
ii.) estimating the speed of the target,
iii.) categorizing the type of target,
iv.) select the type of shot pattern based on the categorization of targets,
v.) fire projectiles based on the selected shot pattern.

According to additional aspects of the method of shot pattern selection when engaging targets with an impact system, the following applies;
that the target can be categorized as any of the following:
i.) a robot,
ii.) a surface craft,
iii.) an airplane,
iv.) a helicopter,
v.) an unmanned aircraft.
that the shot pattern is arranged by firing the projectiles at predetermined time intervals.
that the shot pattern is arranged by moving the launch device vertically between each fired projectile.
that the shot pattern is arranged by moving the launch device horizontally between each fired projectile.
that the projectile is initiated to burst through any of the following;
i.) a received radio signal,
ii.) a predetermined point in time,
iii.) a predetermined position,
iv.) a signal detected by a proximity fuze arranged in the projectile.

The invention furthermore comprises, according to an aspect thereof, a fire-control system for directing fire against a target comprising at least one sensor, in order to measure the position of the target as a function of time, whereas a method of fire control as described above is utilized.

According to additional aspects of a fire-control system for directing fire against a target comprising at least one sensor, in order to measure the position of the target as a function of time, the following applies;
that the sensor for measuring the target's position is a radar.

The invention furthermore comprises, according to an aspect thereof, an impact system comprising a launch device, whereas a fire-control system as described above is applied.

According to further aspects of an impact system, the following applies;
that the firing device is a system comprised of a barrel-based canon.

An advantage of aspects of the present invention is that a target can be combated with greater probability. Since several projectiles can be arranged in a shot pattern, the probability that the target will be combated by the projectiles increases. The arrangement of projectiles in a shot pattern compensates for, among other things;
changes in the target's position,
tolerances related to measuring the target,
tolerances related to the accuracy of the launcher,
tolerances related to propellant accuracy.

### BRIEF DESCRIPTION OF THE DRAWINGS

The invention will be described below by reference to the figures that are included there:

FIG. 1 shows a flowchart of the method for shot pattern selection when combating targets with an impact system according to one embodiment of the invention.

FIG. 2 shows a block diagram of a device for shot pattern selection according to one embodiment of the invention.

FIG. 3 shows a shot pattern according to one embodiment of the invention.

FIG. 4 shows a shot pattern according to one alternative embodiment of the invention.

### DETAILED DESCRIPTION

An ejection device, also termed a cannon, a howitzer, or an artillery piece, in the sense of a naval artillery piece, has the goal of making use of a propellant for the purpose of firing, or ejecting, a projectile. Preferably, a propellant, such as gunpowder, is initiated in one part of the cannon, oftentimes a chamber specifically adapted to the purpose. Initiation takes place by way of igniting the fuze, for instance by means of an ignition cartridge or an igniter in a munitions device, which is initiated by means of striking. Other methods for igniting the propellant may include ignition of the propellant by means of laser energy or electric energy. The propellant burns at a high rate and results in large amounts of gas being produced, which creates a gas pressure in the chamber which propels the projectile out of the barrel of the firing device. The propellant has been adapted in order to generate a constant pressure on the projectile during the entire barrel procedure, to the greatest extent possible, as the projectile movies in the barrel, which results in the projectile leaving the mouth of the barrel with high speed.

Projectiles, such as various types of grenades, generally include some form of warhead and some form of barrel which initiates the warhead. Fuzes can be of various types, and it is common that projectiles intended to burst upon coming into contact with objects to be of the type that requires being struck. Other types of barrels include timed fuzes, in which projectiles are arranged for purposes of bursting at a certain predetermined time, and proximity fuzes, in which projectiles are arranged for purposes of bursting when an object comes within a certain distance from the projectile. The use of proximity fuzes is preferred when confronting flying vessels, while timed fuzes can be used when confronting a large number of various different objects. It is advantageous to combine various types of fuze functions in one and the same fuze, for instance in order for the projectile to burst after a certain time if it fails to detect any object, and so on.

It is advantageous for the warhead to comprise some type of explosive substance, as well as some type of shattering casing which encloses the explosive substance. Various types of propellants, such as fins, can furthermore be arranged in either fuze or on the body of the projectile. The fuze can be programmed electrically, for example by contacting the fuze or by means of inductive/capacitive programming to make the fuze carry out a certain task or fulfill a certain function. The fuze can also communicate wirelessly, for example with radio or optical communication, thus allowing for the function of the function of the fuze during the projectile's journey towards the target.

An attacking guided craft or another target may intend to damage an attack target or a protected object, depending on the perspective from which the attack target or protected object is viewed. Combating the target means that the target is affected so that it can no longer damage the protected object towards which the target is traveling.

A system designed to engage targets using barreled weapons and unguided or guided projectiles can be considered to consist of or comprise three parts: fire control, weapons, and projectiles. Such a system will henceforth be referred to as an impact system. Unguided projectiles refer to various forms of projectiles, such as grenades and rockets, which are intended to be used for combating targets. When guided projectiles are utilized, projectiles with guidance capability are used, after which additional systems for communication with the guided projectiles are added. The guided projectiles can also be autonomous and outfitted with, for instance, target seekers that enable them to guide themselves towards the target. Furthermore, targets can be combated with missiles.

Fire control that constitutes part of an impact system includes one or more sensors, as well as several methods for handling and evaluating sensor data. The sensor or sensors that are included in, and used by, the fire line will henceforth be referred to as sights.

Refined information from the sight is used to control the alignment of both sight and weapon.

A combat process can be considered to consist of or comprise a number of activities. Some activities must take place in sequence while others can take place in parallel.

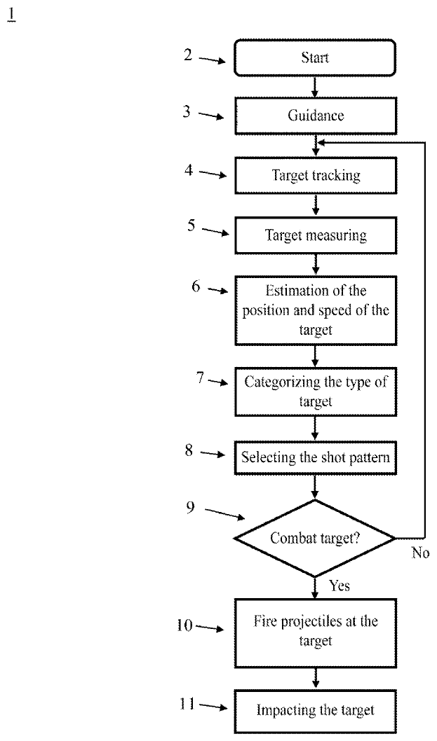

In FIG. 1, a flowchart for a method in a fire-control system 1 is described. When combat begins, start 2 in FIG. 1, the sight is aimed at the target to be combated. This is usually made possible by an external unit, for example a surveillance radar, continuously delivering information about the target's position as a function of time. The external unit can, for example, be arranged on the platform where the firing system is arranged, for example a ship. This external device is called the guidance device. The procedure is called guidance 3.

In parallel with aiming the sight at the target, the barrel, or the action device, can be aimed at a preliminarily calculated forward point, the position of which is based on data from the aiming unit. In this way, the time for firing the barrel is reduced when a more accurate forward point has been calculated because the preliminarily calculated forward point will be close to the more accurate, later calculated forward point.

Completed guidance means that the sight may be able to, itself, measure the position of the target. However, it is not certain that the sight will be able to detect the target immediately even though it is correctly aimed. In cases where the target constantly gets closer, the probability of the sight being able to detect the target increases. The even that takes place when this occurs is called target capture. Target capture is the start of a new sequence called target tracking 4. The sight then controls its own line of sight so that the line of sight follows the target.

When target tracking 4 has been established, target measurement 5 starts. The sight now tries to measure both direction and distance to the target. It is not guaranteed that the sight will be able to measure the distance to the target immediately when a target measurement 5 is started. However, sooner or later, the sight will begin delivering distance data. Meanwhile, the position of the target and the preliminary forward point can be calculated by combining the angle data from the sight and the range data from the guidance device.

When the sight can finally generate both direction data and distance data, no guidance data is longer required for purposes of controlling the sight and barrel. However, guidance data may be used for other purposes.

When the sight measures the position of the target, during target measurement 5, it usually achieves higher frequency and better accuracy than the guidance sensor is capable of This is the basic reason why two types of sensors are used, surveillance sensors and fire-control sensors.

The measurement data is used for an estimation of the target's position and speed 6. The current position and velocity of the target can be estimated from the raw data, for example in the manner already described.

Based on information about the target, the target can be classified in Categorize type of target 7, where type of target can be, for example:
1. Robot
2. Surface craft
3. Airplane
4. Helicopter
5. Unmanned Aircraft

Once the target is categorized, shot patterns can be selected in method step Shot pattern selection 8. The shot pattern can be varied based on the firing distance between projectiles, the variation of the lateral direction of the projectiles n, and the variation in height of the projectiles. Furthermore, the shot pattern can consist of or comprise different projectile types and different order between different projectile types.

At a certain time, a choice can be made to Combat target 9, in the event that the target is not combated, the method can be repeated from step 4 target tracking until a possible better time is available to combat the target.

If the choice is to combat the target, projectiles can be fired at the target as shown in Firing projectiles at the target 10, it is also possible to improve information about the target's trajectory in various ways before firing, for example by estimating the target's acceleration.

In method step Impact on Target 11, the projectiles will burst in order to cause an impact on the target. The impact on the target can be, for example, shrapnel from a warhead arranged in the projectile. The projectiles can burst based on a sensor arranged in the projectile that detects the target or a timed fuze arranged in the projectile that at a certain time bursts the projectile or projectiles. The projectiles can also burst at a certain predetermined position. The projectiles can also explode based on an external command.

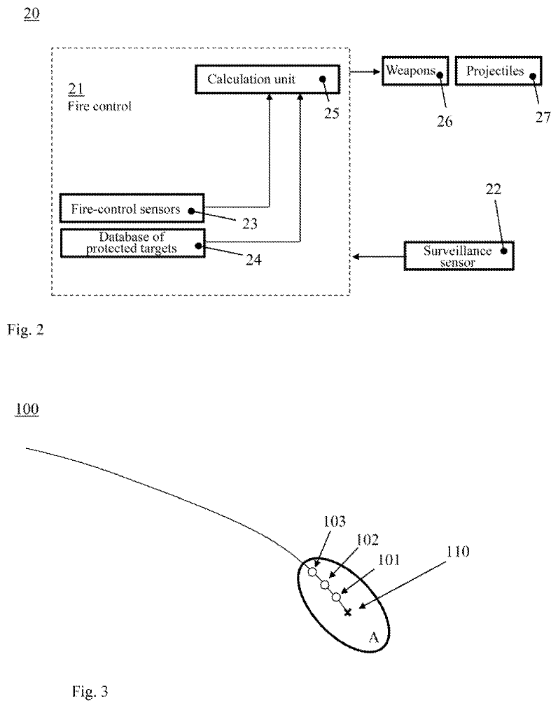

An impact system 20, as shown in FIG. 2, including a type of fire control 21, one or more weapons 26 and projectiles 27 that can be fired at targets. The system 20 receives input from an external surveillance sensor 22, which can search very large volumes with great depth at the expense of accuracy and measurement frequency. The impact system 20 includes a fire-control sensor 23 which, after training, can measure the position of the individual target in a small sector with limited depth, but with high accuracy and high measurement frequency. The calculation unit 25 is used to calculate the forward points towards which the weapon 26 should be aimed. The calculation unit can also classify the type of target based on a certain number of different predetermined categories and, based on this classification, select shot patterns. The fire control 21 may also include a protected object database 24 that contains positions for a number of protected objects that can be found in the immediate area around the impact system 20. Weapons 26 and projectiles 27 can also constitute missiles.

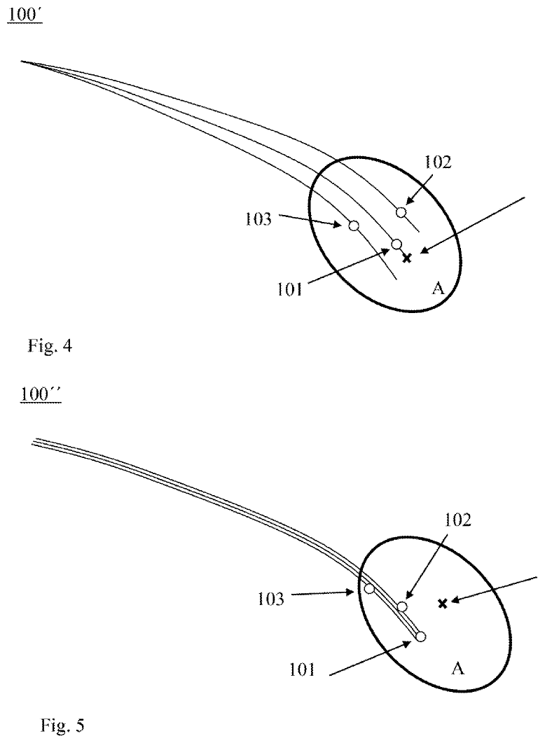

FIG. 3 shows a first shot pattern 100, where three projectiles 101, 102, 103 are fired at a target 110. The first projectile 101 was fired before projectile 102. After projectile 102, projectile 103 was fired. All projectiles were fired from a launcher. The position of the launch device does not change, but the respective projectile is fired within a time interval. In the formation shown in FIG. 3, the projectiles 101, 102 and 103 are located in target area A, where the fragmentation effect from each projectile produces the weapon effect in the target 110. The effect of the projectiles can act synergistically on the target and in target area A, by means of shrapnel being distributed in target area A and acting on target 110.

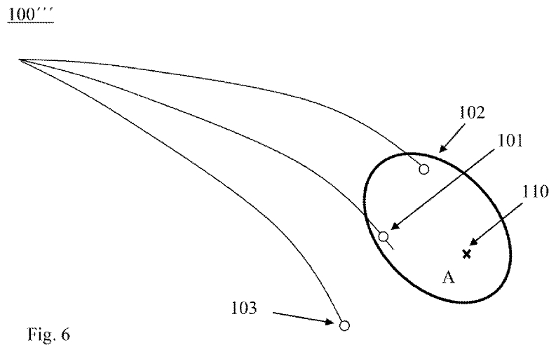

FIG. 4 shows a second shot pattern 100′, where three projectiles 101, 102, as well as 103, have been fired at a target 110. The first projectile 101 was fired before projectile 102. After projectile 102, projectile 103 was fired. All projectiles were fired from a launcher. After projectile 101 is fired, the launch device is moved laterally, after which projectile 102 is fired.

After projectile 102 is fired, the launch device again moves laterally, after which projectile 103 is fired. In the formation shown in FIG. 4, projectiles 101, 102 and 103 are located in target area A, where the fragmentation effect from each projectile produces the weapon effect in the target 110. The effect of the projectiles can act synergistically on the target and in target area A, by means of shrapnel being distributed in target area A and acting on target 110. At a certain time, the warheads of projectiles 101, 102, and 103 detonate simultaneously, near-simultaneously, or in a coordinated fashion.

FIG. 5 shows a third shot pattern 100″, where three projectiles 101, 102, as well as 103, have been fired at a target 110. The first projectile 101 was fired before projectile 102. After projectile 102, projectile 103 was fired. All projectiles were fired from a launcher. After projectile 101 is fired, the launch device is moved laterally, after which projectile 102 is fired. After projectile 102 is fired, the launch device again moves laterally, after which projectile 103 is fired. In the firing pattern shown in FIG. 5, the projectiles 101, 102, 103 have not been separated/distributed to a sufficient degree so as to cover target area A. For this reason, there is a risk that the action in target object 110 cannot be achieved by the projectiles, as the projectiles 101, 102, 103 are too tightly clustered.

FIG. 6 shows a fourth shot pattern 100′″, where three projectiles 101, 102, as well as 103, are fired at a target 110. The first projectile 101 was fired before projectile 102. After projectile 102, projectile 103 was fired. All projectiles were fired from a launcher. After projectile 101 is fired, the launch device is moved laterally, after which projectile 102 is fired. After projectile 102 is fired, the launch device again moves laterally, after which projectile 103 is fired. In the firing pattern shown in FIG. 6, the projectiles 101, 102, 103 have been separated/distributed with too large a spread to be able to cover target area A. For this reason, there is a risk that the action in target object 110 cannot be achieved by the projectiles, as the projectiles 101, 102, 103 are distributed with two large a spread, which means that there is a risk that the target object will be missed.

Due to the ability to select the shot pattern based on the target category, improved impact on the target can be achieved. For example, a robot, a surface craft, an airplane, a helicopter, and an unmanned aircraft all have different maximum and minimum speeds, a speed range, which can be used to improve their impact on the target object. For example, in cases where the velocity range is small, such as is the case with a surface craft, the projectiles in the shot pattern can be gathered within a smaller area in order to achieve an improved coordinated impact. In cases where the velocity range is large, as for a robot, the projectiles in the shot pattern can be distributed over a larger area in order to increase the probability of impact on the target. The shot pattern can be designed to be distributed vertically, laterally, and longitudinally. For instance, vertical and lateral direction are achieved by redirecting the fire tube between the respective fired projectile or with a control device arranged in the projectile, and where changes in longitudinal direction are arranged through a time slot between fired projectiles or with a braking device arranged in the projectile. Thus, a shot pattern is the distribution of projectiles in a space.

The invention is not limited to the embodiments specifically shown, but can be varied in different ways within the framework of the claims.

For instance, it is clear that the elements and details included in the method for directing fire towards targets, such as the number of sensors, firing devices or systems, are to be adapted to the weapons system, platform or other construction properties which currently apply.

The categorization of targets can also include the type of robot, such as naval target robot, anti-aircraft robot or other types of robots. As well as for surface craft, type of craft such as a manned or unmanned surface craft and whether it is a combat-technical surface craft. As well as for aircraft what type of aircraft. As well as for helicopters what type of helicopter. As well as for unmanned aircraft, any type of aircraft, such as tactical UAV or combat technical UAV.

It is to be understood that the method described above for directing fire against targets can be applied to basically all unguided or guided craft and systems including aircraft, unmanned flying craft and missiles, surface-going ships or underwater craft that are possible to measured.

1. Method for shot pattern selection when combating targets with an impact system, comprising
estimating a position of the target,
estimating a speed of the target,
categorizing a type of target,
selecting a type of shot pattern based on the categorization of the target,
firing projectiles based on a selected shot pattern.

2. Method for shot pattern selection when combating targets with an impact system according to claim 1 wherein the target is one of;
a robot,
a surface craft,
an aircraft,
a helicopter,
an unmanned aircraft.

3. Method for shot pattern selection when combating targets with an action system according to claim 1, wherein the shot pattern is arranged by firing the projectiles at predetermined time intervals.

4. Method for shot pattern selection when combating targets with an action system according to claim 3, wherein the shot pattern is arranged by moving the launch device vertically between each fired projectile.

5. Method for shot pattern selection when combating targets with an action system according to claim 3, characterized in that the shot pattern is arranged by firing the projectiles at predetermined time intervals.

6. Method for shot pattern selection when combating targets with an impact system according to claim 1 wherein the projectile is initiated to burst through any of;
a received radio signal,
a predetermined time,
a predetermined position,
a signal detected by a proximity fuze arranged in the projectile.

7. Fire-control system for directing fire against a target comprising an arrangement comprising at least one sensor with the purpose of measuring the position of the target as a function of time the arrangement being configured to estimate a position of the target, estimate a speed of the target, categorize a type of target, select a type of shot pattern based on the categorization of the target, and fire projectiles based on a selected shot pattern.

8. Fire-control system for directing fire against a target comprising at least one sensor with the purpose of measuring the position of the target as a function of time according to claim 7, wherein the sensor for measuring the target's position is a radar.

9. Impact system including a firing device, wherein a fire-combat system according to claim 7 is utilized.

10. Impact system according to claim 9, wherein the firing device is a barrel-based canon system.
